(19) United States
(12) Patent Application Publication
(10) Pub. No.: US 2012/0244256 A1
(43) Pub. Date: Sep. 27, 2012

(54) Method For Manufacturing Processed Marine Plant Food

(76) Inventors: Park JONG-NAM, Incheon (KR); Sim Sang-Cheon, Incheon (KR)

(21) Appl. No.: 13/071,245

(22) Filed: Mar. 24, 2011

(51) Int. Cl. A23L 1/0532; A23P 1/08; A23P 1/06; A23L 1/30; A23P 1/12; A23L 3/40

(52) U.S. Cl. 426/61; 426/575

(57) ABSTRACT

A method is provided for manufacturing a processed marine plant food. It comprises (a) crushing marine plants into small pieces; (b) heating the marine plant pieces together with alkaline salts at a temperature of from 40 to 80° C. while stirring in a vacuum stirrer to generate a marine plant paste; and (c) gelling the marine plant paste with a metal ion solution of di- or higher valency to form a marine plant jelly. When manufactured by the method, the marine plant food retains its characteristic taste, flavor and color, without their components beneficial to the body being lost or denatured.

CROSS-REFERENCE TO RELATED APPLICATION

Not Applicable

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

1. Field of the Invention

The present invention relates to a method for manufacturing processed marine plant food. More particularly, the present invention relates to a method for processing marine plants into a food rich in biologically active ingredients, while maintaining their characteristic taste, flavor and color, without losing or denaturing nutritional or functional components.

2. Description of the Related Art

Marine plants are used as food, fodder and for manure. Recently, marine plants have been gaining attention as a source of bio-fuel. There are various kinds and tremendous amounts of marine plants. Great advances in artificial culturing technology allow marine plants to be produced in great quantities every year. With the recognition of marine plants as health foods, the consumption thereof has also increased. Typical among the uses of marine plants is as an additive for various foods.

Marine plants are abundant in nutrition and functional ingredients. A variety of biologically active, functional ingredients are found in marine plants such as taurine, unsaturated fatty acids, alginic acid, fucoidan, laminarin, dietary fibers, etc., as well as vitamins and minerals. Of marine plants, for example, sea mustard and laminaria are reported to be rich in minerals (e.g., potassium, calcium, iron, phosphorus, sodium, etc.), edible fiber, folic acid, and vitamins, and to contain biologically active components in large quantities such as alginic acid and fucoidan. Alginic acid is known to have the physiological effect of lowering cholesterol levels and blood pressure, and suppressing the generation of harmful oxygen. One report suggests that fucoidan has antibacterial qualities, antioxidant qualities, antiviral and anticancer qualities, as well as being effective in the prevention of adult diseases such as arteriosclerosis, myocardial infarction, hypertension, angina pectoris, and stroke.

As mentioned above, biologically active and functional components are found in abundance in marine plants. However, they are difficult to distribute in the crude state they are in when taken from the sea. Marine plants therefore need to be processed before distribution to the consumer. Typically, marine plants are processed by salting or by extraction. However, salting makes it difficult to eat marine plants because of the high sodium. Furthermore, the uptake of too much salt is not healthy. Accordingly, extraction is preferred. Extraction may be typically conducted with hot water or high pressure.

Hot-water extraction is disadvantageous because it tends to yield a low level of desired products during processing. In addition, the high temperature involved in hot-water extraction diminishes the taste, flavor and color of marine plants in their natural state, and leads to a loss of nutritional and functional components beneficial for the human body. In contrast, high-pressure extraction guarantees a high yield in a short time frame. However, the high pressure is dangerous. Maintaining high pressure at a constant volume generates heat, resulting in the denaturation of beneficial components. Moreover, high-pressure extraction is difficult to commercialize because it requires expensive facilities and high operating costs.

There is, therefore, a need for a method of processing marine plants into food, while maintaining their characteristic taste, flavor and color, and without losing or denaturing nutritional and functional components beneficial to the human body. In addition, economical and practical aspects must be taken into account.

On the other hand, marine plants may contain environmental hormones (e.g., dioxin), albeit in trace amounts. These detrimental components may be introduced during processing and/or transportation, or may originate from packaging materials (synthetic resins, pulps, etc.). They may also come from sea pollutants, which have been on the rise. Therefore, when marine plants are processed, the removal of detrimental components, such as environmental hormones or heavy metals, must be taken into consideration.

3. Objectives

It is therefore an object of the present invention to provide a method for processing marine plants into food, while maintaining their characteristic taste, flavor and color, and without losing or denaturing components that are beneficial for the human body.

It is another object of the present invention to provide a method for processing marine plants into food by which detrimental components are removed from the marine plants or excreted from the human body, leaving a high concentration of beneficial components.

### SUMMARY OF THE INVENTION

In accordance with an aspect thereof, the present invention provides a method for processing marine plants into foods, comprising the steps of:

(a) crushing marine plants into small pieces;

(b) heating the marine plant pieces together with alkaline salts at a temperature in the range of 40 to 80° C. while stirring in a vacuum stirrer, to generate a marine plant paste; and

(c) gelling the marine plant paste with a metal ion solution of di-, or higher valency, to form a marine plant jelly.

In one embodiment of the present invention, step (c) comprises molding the marine plant paste by extrusion in an extruder and immersing the extrusion molded paste in a di-, or higher valency, metal ion solution to afford a gelled marine plant jelly.

In another embodiment, the method further comprises the following additional steps of:

(d) drying and pulverizing the marine plant jelly into a marine plant powder;

(e) placing the marine plant powder in a vacuum chamber;

(f) spray-coating the marine plant powder with a chlorella solution while moving the marine plant powder under vacuum in a vacuum chamber; and

(g) drying the chlorella-coated marine plant powder.

As mentioned above, the method of the present invention affords a marine plant food that retains the taste, flavor and color characteristics of marine plants, without losing and denaturing components beneficial for the human body.

Also, the method provides a marine plant food that has nutritional components and components that are functionally beneficial in terms of excreting detrimental components which may be present within marine plants.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating a coating system useful in the present invention.

Reference Numerals

| | |
|---|---|
| 10: Vacuum Chamber | 12: Vacuum Vessel |
| 14: Cap | 16: Stirrer |
| 20: Vacuum Pump | 30: Sprayer |
| 32: Reservoir | 34: Delivery Pump |
| 36: Nozzle | 40: Pressure Gauge |
| 50: Storage Tank | |

### DESCRIPTION OF THE PREFERRED EMBODIMENTS

In accordance with the present invention, the method for processing marine plants into foods comprises the following steps:

(a) crushing the marine plants;

(b) turning the marine plants into a paste by heating at a low temperature in a vacuum;

(c) turning the marine plants into a gel.

Steps (a) to (c) are consecutive. These steps result in a processed marine plant food in jelly form. The content of the marine plants in the processed food (jelly) approaches almost 100 wt %. The processed food (jelly) may be distributed to consumers after packaging or further processing. Below, a stepwise description is given of the method of the present invention.

(a) Crushing of Marine Plants

Making homogeneous paste from marine plants first requires crushing the marine plants. First, marine plants are preferably washed with clean water. For example, marine plants are washed with flowing water to remove impurities. Preferably, marine plants are washed and swelled (hydrated) by immersion in clean water for 0.5 to 5 hrs. The water may be either seawater or fresh water. After washing, the marine plants are crushed into a suitable size. For example, the crushed marine plant pieces are as small as those passing through a 500 mesh sieve. Preferably, they are crushed to a size of 200 mesh or less, and more preferably, to a size between 50 to 200 mesh.

No limitations are imparted to the kind of marine plants useful in the present invention. Marine plants that are raw (i.e., as taken from sea), dry (i.e., dried raw marine plants), or salted (i.e., preserved with salt) can be used. As mentioned above, these marine plants are washed with water and then crushed to a suitable size. The marine plants may be selected from among red algae, brown algae, green algae, and a combination thereof. Among red algae, are Gelidium amansii, laver, Gelidium divaricatum, hypneaceae, ceramiaceae and Ceramium boydenii. Examples of brown algae include sea mustard, laminaria, whip tube, Ecklonia cava, Sargassaceae and hijikia fusiforme. Spirogyra, Enteromorpha, sea staghorn, and Nostocaceae are examples of green algae. However, the marine plants useful in the present invention are not limited to these examples, and preferably are selected from brown algae. In detail, they are preferably selected from among sea mustard, laminaria, Gelidium amansii and Gelidium divaricatum, with preference for sea mustard or laminaria.

(b) Turning Marine Plants into a Paste by Heating at a Low Temperature in a Vacuum

The crushed marine plants are heated at a low temperature in a vacuum to produce a paste. This paste may be obtained by heating the crushed marine plants at a temperature between 40 to 80° C. in a vacuum stirrer. This may require an alkaline salt. In detail, the crushed marine plants are fed together with an alkaline salt into a vacuum stirrer and heated to a low temperature between 40˜80° C., while stirring, to yield a paste. Beneficial components are eluted and turned into a paste by stirring at a low temperature in a vacuum. The low-temperature stirring is preferably conducted for 30˜120 min. For example, if the marine plants are heated for too short a time, the elution of beneficial components may be insufficient. On the other hand, heating for too long may have an adverse influence in terms of the maintenance of inherent characteristics. That is, when heated for too long, the marine plants may lose their characteristic tastes, flavors and colors.

The alkaline salt may be selected from the group consisting of potassium carbonate, sodium hydrogen carbonate, ammonium hydrogen carbonate, ammonium chloride, disodium phosphate, dipotassium phosphate, sodium carbonate, and a combination thereof. These alkaline salts may be in solution form when fed into the vacuum stirrer. The alkaline salt may be used in an amount in the range 0.01 to 10 parts by weight based on 100 parts by weight of the crushed marine plants, and preferably in an amount between 0.1 to 4.0 parts by weight based on 100 parts by weight of dry crushed marine plants.

Alkaline salt facilitates the elution of beneficial components from marine plants and particularly, helps elute alginic acid from marine plants. Accordingly, alginic acid is eluted without additional treatment and can be obtained in a jelly form that can be used in processed food. Alginic acid, a viscous anionic polysaccharide distributed widely in the cell walls of marine plants, gels up (solidifies) when it reacts with divalent metal ions.

According to the present invention, by heating at a low temperature of 40˜80° C. in a vacuum, the pasting process allows the paste to retain the characteristic properties of marine plants. In addition, this process not only elutes beneficial components, such as nutrients or functional components, but also prevents the loss or denaturation of the beneficial components due to the low temperature thereof. As mentioned above, the low-temperature heating is preferably conducted between 40˜80° C. A temperature less than 40° C. decreases the efficiency with which beneficial components are eluted, making it difficult to obtain a paste. On the other hand, when the temperature exceeds 80° C., the characteristic properties (taste, flavor and color), as well as the beneficial components of marine plants, are apt to be lost, disappear or be denatured during the pasting process. In addition, the alkaline salt used in the low-temperature heating facilitates the elution of alginic acid. As the eluted alginic acid gels, a processed food is obtained in a highly viscoelastic jelly form without any additional treatment.

In one embodiment of the present invention, alginic acid may be externally added during low-temperature heating (the pasting step). For example, alginic acid may be used in an amount between 0.05 to 4.0 parts by weight based on 100 parts by weight of the crushed marine plant. In this context, alginic acid may be added in the form of an aqueous solution. The addition of alginic acid guarantees a smoother and tastier processed food (the jelly).

(c) Gelation of Marine Plant Paste

A gel of the marine plant paste is created with a metal ion solution of di- or higher valency. As described above, when the marine plants are heated at a low temperature in the presence of an alkaline salt in a vacuum, a quantity of alginic acid is eluted and reacts with di-, or higher valency, metal ions to gel up into jelly (i.e., marine plant jelly).

As long as it contains di-, or higher valency, metal ions, any metal ion solution may be used. Preferably, the metal ion solution may contain metal ions selected from among Ca²⁺, Mg²⁺, and a combination thereof. For example, the metal ion solution may be a solution (e.g., aqueous solution) of a compound selected from the group consisting of calcium lactate, calcium chloride, calcium citrate, calcium carbonate, calcium hydroxide, magnesium chloride, calcium sulfate, and a combination thereof. The metal ions of the metal ion solution react with the carboxylic acid moiety of the alginic acids to crosslink the alginic acids, thus resulting in a viscoelastic jelly having a network structure. The metal ion solution may be an aqueous solution containing metal ions in an amount between 0.1˜5% by weight, but is not limited thereto. A preferable example of the metal ion solutions is a calcium ion solution. This may be prepared by dissolving shells or eggshells with an acidulant, such as vinegar.

In the context of preparing a marine plant jelly through gelation, the marine plant jelly may have a predetermined shape. For example, the gelling process, that is, step (c), may comprise molding the marine plant paste into a predetermined form using an extruder and immersing the extrudate in a solution of di-, or higher valency, metals to afford a marine plant gel. The gelling process may be performed by immersing the extrudate for, for example, 3˜10 mins in a bath containing a solution of di-, or higher valency, metal ions. The extrudate jelly may have various shapes. Examples of the shapes include cylinders, polygonal columns, plates, and globes, but are not limited thereto.

In accordance with one embodiment, the gelation step, that is, step (c), may be conducted in such a manner that gelation and molding occurs at the same time by extrusion molding the marine plant paste in the presence of di-, or higher valency, metal ions.

The marine plant jelly thus prepared may be packaged before distribution to consumers. Preferably, the marine plant jelly is sterilized and then packaged or vice versa, followed by distribution to consumers. For example, the marine plant jelly may be packaged along with preservative water within a container (e.g., a polyethylene or polypropylene pouch), and sterilized with heat before distribution to consumers. The water used for preservation may be selected from among ozone water, purified water and saline, and may be used in one to three volumes of marine plant jelly.

Furthermore, the heat treatment for sterilization may be conducted using steam under high pressure, primarily at 80˜100° C. for 2˜30 mins, and secondarily at 100˜130° C. for 2˜30 mins. Alternatively, the marine plants may be sterilized in a package in such a manner that the package is immersed for 10˜120 mins in a water bath of 80˜100° C.

Meanwhile, marine plants may contain harmful components, such as environmental hormones or heavy metals, albeit in trace amounts. These harmful components may be removed from the marine plants or excreted from the human body by chlorella. Chlorella (e.g., Chlorella pyrenoidosa) is a phytoplankton, a genus of single-celled green algae, having a spherical figure with a size of about 0.002 to 0.1 microns. Upon uptake into the human body, chlorella is known to have the function of excreting environmental hormones (e.g., dioxin) or heavy metals from the body. In addition, reports suggest that chlorella contains various nutrients, including proteins, carbohydrates, lipids, vitamins, minerals, chlorophyll, dietary fibers, etc., and serve biologically active functions, including promoting growth, preventing cancer, enhancing the immune response (immunopotentiation), controlling blood cholesterol and blood pressure levels, and rejuvenating cells.

When applied to processed marine plant food, therefore, chlorella can function to remove detrimental components, such as environmental hormones or heavy metals (via excretion from the body), as well as providing nutritional and/or physiological benefits. The removal (excretion) of detrimental components, such as environmental hormones and heavy metals, by chlorella is known. Also, techniques of preparing chlorella solutions, e.g., 40-fold concentrated chlorella solutions, are common knowledge. More beneficial effects can be obtained as larger amounts of chlorella are applied to the processed marine plant food. In this context, the method for processing marine plants into food in accordance with the present invention may further comprise (d) drying and pulverizing the marine plant jelly into a powder; (e) placing the marine plant powder in a vacuum chamber; (f) spray-coating the marine plant powder with a chlorella solution while moving the marine plant powder about under vacuum in a vacuum chamber; and (g) drying the chlorella-coated marine plant powder.

No particular limitations are imparted in step (d). In step (d), the marine plant jelly obtained in step (c) may be dried with hot air, cold air, or naturally at room temperature, or freeze-dried and then powdered. For example, the dried marine plant jelly may be pulverized into a size of about 50˜200 mesh.

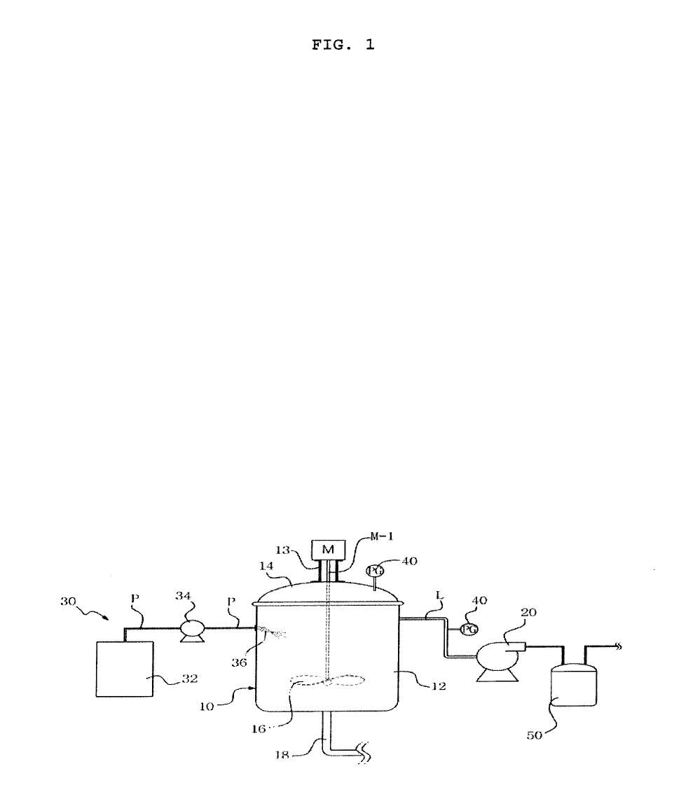

Steps (e) and (f) will now be described in detail with reference to FIG. 1. FIG. 1 schematically illustrates a coating system useful in the present invention.

As shown in FIG. 1, the coating system comprises a vacuum chamber 10, a vacuum pump 20, and a sprayer 30.

The vacuum chamber 10 has a vacuum vessel 12 and a cap 14, hermetically engaged with the vacuum vessel 12. The interior of the vacuum chamber 10 is installed with a stirrer 16 which stirs the marine plant powder to move it around. The operation of the stirrer 16 is driven by a motor M provided inside or outside the vacuum chamber 10. When the motor M is installed outside the vacuum chamber 10, a vacuum pipe 13 is hermetically sealed atop the cap 14 and the motor M is installed on the vacuum pipe 13 in such a sealing structure that a motor axis M-1 is present within the vacuum pipe 13 in a vacuum.

To decrease the internal pressure of the vacuum chamber 10 to a vacuum, that is, a pressure less than the atmospheric pressure 760 mmHg, the vacuum pump 20 communicates with the vacuum chamber 10 via a pipe line L.

The sprayer 30 is provided for spraying a chlorella solution in a predetermined amount into a vacuum chamber 10. No limitations are imparted to the structure of the sprayer if it is adapted to spray achlorella solution into the vacuum chamber 10. In an illustrative embodiment, as shown in FIG. 1, the sprayer 30 comprises a reservoir 32 containing a chlorella solution, a delivery pump 34 for discharging the chlorella solution from the reservoir 32 to the vacuum chamber 10, and a nozzle 36 for spreading the chlorella solution foggily. The reservoir 32, the delivery pump 34 and the nozzle 36 are connected with each other by a pipe P which leads to the vacuum chamber 10. A sealing member such as a rubber ring is provided between the pipe P and the vacuum chamber 10 to uphold the vacuum condition.

Preferably, the coating system comprises a pressure gauge 40 for measuring the internal pressure of the vacuum chamber 10. At least one pressure gauge 40 is installed within the system. For example, the pressure gauge 40 may be provided, as shown in FIG. 1, on the vacuum chamber 10. In addition, the pressure gauge 40 may be installed on the pipe line L between the vacuum chamber 10 and the vacuum pump 20.

In addition, the coating system may further comprise a storage tank 50 at the rear of the vacuum pump 20 so that when the content (chlorella solution and marine plant powder) of the vacuum chamber 10 is released by operation of the vacuum pump 20, it can be accommodated by the storage tank.

The operation (working and stopping) of the vacuum pump 20 may be controlled manually, but may be preferably controlled automatically by a controller (not shown). In one embodiment, the coating system of the present invention may further include a controller (not shown) for controlling the operation (working and stopping) of the vacuum pump 20 in response to the pressure measurement of the pressure gauge 40. Also, the coating system may further comprise a timer which records the period of time from the point at which the internal pressure of the vacuum chamber 10 is decreased to a predetermined vacuum (less than 760 mmHg, e.g., 740 mmHg˜60 mmHg as measured by the pressure gauge) to the point at which, for example, the spraying process is terminated. In the coating system, the vacuum chamber 10 may be provided at the bottom thereof with an outlet through which the chlorella-coated marine plant powder is discharged.

The coating system can be usefully applied to the present invention. In conjugation with the coating system, steps (e) and (f) will be described in detail. However, the operation of steps (e) and (f) is not limited to the use of the coating system of FIG. 1.

First, the marine plant powder obtained in step (d) is placed in the vacuum chamber 10. Then, the vacuum pump 20 is operated to keep the internal pressure of the vacuum chamber 10 below atmospheric pressure (i.e., less than 760 mmHg). An illustrative, non-limiting internal pressure of the vacuum chamber 10 is on the order of 740 mmHg˜60 mmHg as measured by the pressure gauge 40. Under such a vacuum condition, the stirrer 16 is operated to stir the marine plant powder during which a chlorella solution is sprayed through the sprayer 30 into the vacuum chamber 10 to coat the marine plant powder with the chlorella solution. As for the time period for the coating, that is, the residence time of the marine plant powder within the vacuum chamber 10, it may be, but is not limited to, 30 mins˜2 hrs.

As such, coating under vacuum conditions results in coating with a higher amount of chlorella solution than does a typical immersion or spray-coating method. The marine plant powder prepared in step (d) has micropores therein. The air filling the micropores is evacuated by vacuuming so that the chlorella solution can occupy the micropores instead of the air. Accordingly, the chlorella solution is not only absorbed into the surface of the powder, but also infiltrates the powder. In addition, the vacuum condition increases the adsorption and infiltration speeds of the chlorella solution. As a result, the amount of the chlorella solution with which the powder is coated is increased.

After the chlorella solution is applied (absorbed/infiltrated) to the marine plant powder within the vacuum chamber 10, the marine plant powder (coated with the chlorella solution) is harvested from the vacuum chamber 10 and dried. In this regard, it may be dried with hot or cold air, or naturally at room temperature, or freeze-dried.

When further processed by steps (d) to (g), the resulting marine plant powder contains a high chlorella content. The processed marine plant food in the form of a powder may be used as a food additive, or may be formulated into, for example, pills before distribution to consumers. The processed marine plant food contains chlorella-derived nutrients, such as proteins and minerals, as well as the nutritional and functional components of the marine plants themselves. In addition, the processed marine plant food can be imparted with the biologically active functions of chlorella, including promoting growth, preventing cancer, enhancing the immune response (immunopotentiation), controlling blood cholesterol and blood pressure levels, and rejuvenating cells. Furthermore, when present in marine plants, detrimental components (e.g., environmental hormones or heavy metals) may be removed (excreted) from the human body by chlorella.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for manufacturing a processed marine plant food, comprising:
(a) crushing marine plants into small pieces;
(b) heating the marine plant pieces together with alkaline salts at a temperature from 40 to 80° C., while stirring in a vacuum stirrer, to generate a marine plant paste; and
(c) gelling the marine plant paste with a metal ion solution of di-, or higher valency, to form a marine plant jelly.

2. The method according to claim 1, wherein step (c) comprises:
extrusion molding the marine plant paste in an extruder; and
immersing the extrusion molded paste in a metal ion solution of di-, or higher valency, to produce a gelled marine plant jelly.

3. The method according to claim 1, wherein step (c) is conducted by extrusion molding the marine plant paste in the presence of a metal ion solution of di-, or higher valency, in an extruder.

4. The method according to claim 1, wherein the alkaline salt is selected from the group consisting of potassium carbonate, sodium hydrogen carbonate, ammonium hydrogen carbonate, ammonium chloride, disodium phosphate, dipotassium phosphate, sodium carbonate, and a combination thereof.

5. The method according to claim 1, wherein the metal ion solution is a solution of a compound selected from the group consisting of calcium lactate, calcium chloride, calcium citrate, calcium carbonate, calcium hydroxide, magnesium chloride, calcium sulfate, and a combination thereof.

6. The method according to one of claim 1, further comprising:
(d) drying and pulverizing the marine plant jelly into a marine plant powder;
(e) placing the marine plant powder into a vacuum chamber;
(f) spray-coating the marine plant powder with a chlorella solution while moving the marine plant powder about under vacuum in a vacuum chamber; and
(g) drying the chlorella-coated marine plant powder.

7. The method according to one of claim 2, further comprising:
(d) drying and pulverizing the marine plant jelly into a marine plant powder;
(e) placing the marine plant powder into a vacuum chamber;
(f) spray-coating the marine plant powder with a chlorella solution while moving the marine plant powder about under vacuum in a vacuum chamber; and
(g) drying the chlorella-coated marine plant powder.

8. The method according to one of claim 3, further comprising:
(d) drying and pulverizing the marine plant jelly into a marine plant powder;
(e) placing the marine plant powder into a vacuum chamber;
(f) spray-coating the marine plant powder with a chlorella solution while moving the marine plant powder about under vacuum in a vacuum chamber; and
(g) drying the chlorella-coated marine plant powder.

9. The method according to one of claim 4, further comprising:
(d) drying and pulverizing the marine plant jelly into a marine plant powder;
(e) placing the marine plant powder into a vacuum chamber;
(f) spray-coating the marine plant powder with a chlorella solution while moving the marine plant powder about under vacuum in a vacuum chamber; and
(g) drying the chlorella-coated marine plant powder.

10. The method according to one of claim 5, further comprising:
(d) drying and pulverizing the marine plant jelly into a marine plant powder;
(e) placing the marine plant powder into a vacuum chamber;
(f) spray-coating the marine plant powder with a chlorella solution while moving the marine plant powder about under vacuum in a vacuum chamber; and
(g) drying the chlorella-coated marine plant powder.
